(19) United States
(12) Patent Application Publication
(10) Pub. No.: US 2006/0271954 A1
(43) Pub. Date: Nov. 30, 2006

(54) Whole-House Video Network

(76) Inventors: Douglas Edward Lankford, Carmel, IN (US); Keith Reynolds Wehmeyer, Fishers, IN (US); Mike Arthur Derrenberger, Fishers, IN (US); Terry Wayne Lockridge, Dayton, OH (US); Kumar Ramaswamy, Princeton, NJ (US)

Correspondence Address: THOMSON LICENSING INC., PATENT OPERATIONS, PO BOX 5312, PRINCETON, NJ, 08543-5312, US

(21) Appl. No.: 10/548,891

(22) PCT Filed: Mar. 8, 2004
(86) PCT No.: PCT/US04/07066

§ 371 Date: Sep. 12, 2005

Related U.S. Application Data
(60) Provisional application No. 60/453,765, filed on Mar. 11, 2003.
(60) Provisional application No. 60/453,663, filed on Mar. 11, 2003.

(51) Int. Cl. H04N 5/445

(52) U.S. Cl. 725/40

(57) ABSTRACT

A home satellite system includes a satellite antenna for receiving satellite broadcast video signals, and a satellite receiver that can provide the broadcast video signals to a first television directly coupled to the satellite receiver, to a second television via a in-house coaxial cable, and to a third television through a wireless network. The channel displayed in each television can be individually tuned. The satellite receiver further provides a call back link, which is shared by all the televisions, to a video source for billing or other purposes.

### CROSS-REFERENCE TO RELATED APPLICATIONS

This application claims the benefit of U.S. Provisional Patent Application 60/453,663 and 60/453,765, both filed Mar. 11, 2003.

### TECHNICAL FIELD OF INVENTION

This invention relates to the field of satellite broadcast system, and, more particularly, to a satellite receiver/server at a home for distributing satellite broadcast video through coaxial cables and a wireless network.

### BACKGROUND OF THE INVENTION

Generally, a satellite television system at a home includes an antenna (including a dish), a low noise block down-converter (LNB), a satellite receiver, and a television (TV) set. A satellite receiver allows a user to tune to a channel for viewing, and is normally connected to a TV set directly. If a user wants another TV with independent channel control, the user needs to use another satellite receiver. The user needs yet another receiver, if the user desires to distribute broadcast programs to television sets through existing home coaxial cables conventionally used for cable broadcasting. Furthermore, the user needs another satellite receiver if the user wants to wirelessly distribute the broadcast programs to a display, such as a high-definition TV or a PC monitor, located in a room where the coaxial cable cables do not reach. Thus, to provide a whole-house video network, several satellite receiver boxes are needed. The multiplicity of satellite receivers not only confuses a user but also significantly increases the cost to the user.

In additional to the cost of buying additional satellite receivers, each additional satellite receiver generally is placed in a different room. As such, each room requires a telephone jack for accessing a telephone call back link. (A call back link is provided to communicate billing or other information from a satellite receiver to a video source.) However, generally, not every room in a house is provided with a telephone jack. Thus, there is a need for providing a home satellite receiver (server) that can accommodate the above needs but with reduced cost to a user.

### SUMMARY OF THE INVENTION

According to the principles of the invention, a receiver includes an input terminal for receiving broadcast signals of a plurality of channels; a first output terminal for providing first baseband video signals corresponding to broadcast signals from a first channel; and a second output terminal for providing network packets corresponding to broadcast signals from a second channel for transmitting to a network coupled to the second output terminal.

The receiver further includes a third output terminal for providing first and second analog video signals respectively corresponding to broadcast signals of third and fourth channels. The first and second analog video signals respectively have first and second frequency bands transmissible in a transmission medium, such as a RG-59 cable, coupled to a third output terminal, wherein the first frequency band is different from the second frequency band.

The first and second analog video signals are encoded with a standard television format, such as NTSC, PAL, or SECOM, so that an analog television can receive and process the analog video signals.

The satellite receiver responds to more than one remote control and tunes to the channels in response to remote control signals from respective remote controls.

### BRIEF DESCRIPTION OF DRAWINGS

FIG. 1 is an illustrative home satellite system including a satellite antenna and a satellite receiver according the principles of the invention.

FIG. 2 is an illustrative embodiment of the satellite receiver in the home satellite system shown in FIG. 1.

### DETAILED DESCRIPTION

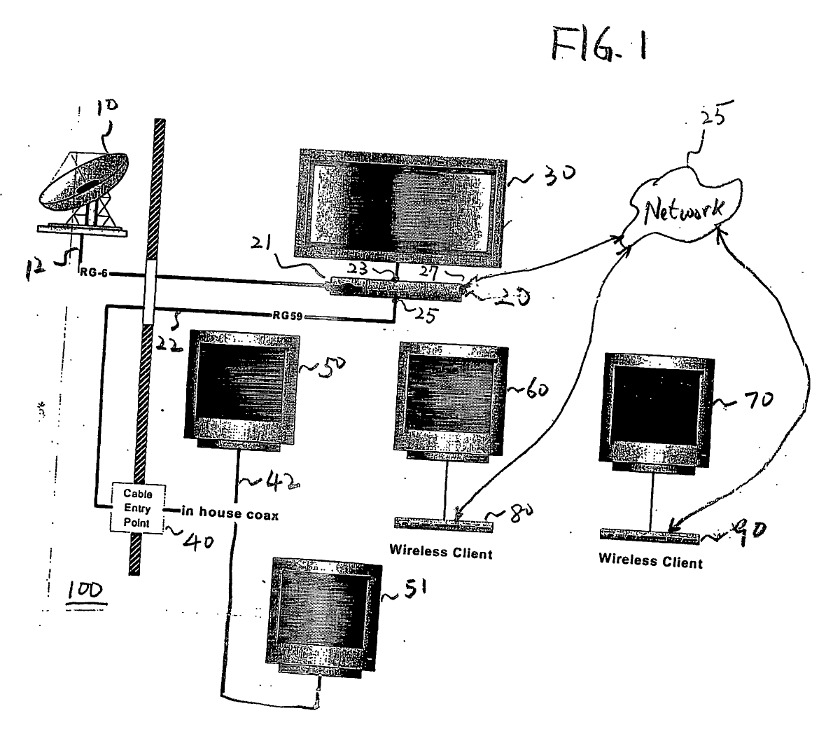

FIG. 1 illustrates a home satellite system 100 according to the principles of the invention. The system 100 includes an antenna 10 for receiving broadcast video signals from a broadcast source, and a satellite receiver 20 for distributing broadcast video signals to televisions 30, 50, 51, 60, and 70.

The broadcast source may be, but not limited to, a satellite or a terrestrial source. The antenna 10 normally includes a dish and a feedhorn for receiving the satellite video signals and a low noise block (LNB) for amplifying the received satellite video signals and translating all of the satellite's carrier frequencies to a first IF (intermediate frequency) frequency, usually 950 to 1450 MHz (megahertz) in the L band. This down conversion of satellite carrier frequencies permits connection from the antennal 10 and the satellite receiver to be made through a coaxial cable 12, such as a RG-6 cable, rather than a waveguide, which is much more expensive. The feedhorn and the LNB are not shown in the figure.

Illustratively, each television is associated with a RF remote control (not shown) for sending a remote control signal including channel select information to the satellite receiver 20, which tunes to the specified channel for that television. The satellite receiver 20 illustratively can tune to a different channel for each television, so that each television can display a different television program simultaneously. Upon receiving the broadcast video signals at an input terminal 21 from the antenna 10, the satellite receiver 20 tunes to channels in response to respective remote control signals, and provides the video signals from the respective channels to televisions 30, 50, 51, 60, and 70.

In this illustration, the satellite receiver 20 via an output terminal 23 provides tuned video signals to the television 30, which is directly coupled to the satellite receiver 20 and may be, but not limited to, a display supporting HDTV (High Definition Television) formats. The satellite receiver 20 via another output terminal 25 provides video signals to the televisions 50 and 51, which may be, but not limited to, SDTVs (Standard Definition Televisions), via a coaxial cable 22 connected to a cable entry point 40, which is coupled to an in-house coaxial cable system 42. The coaxial cables 22 and cables used in the in-house coaxial system 42 should be, but not limited, to RG-59 cables, and the carrier frequencies of the video signals should be less than one GHz (gigahertz) to reduce the transmission loss in the in-house coaxial cable system 42. Other transmission media, such as other types of cable, optical fiber, and air can be used as well.

Finally, the satellite receiver 20 via an output terminal 25 wirelessly provides tuned video signals to the televisions 60 and 70 by sending the tuned video signals to their respective wireless network clients 80 and 90. The output terminal 25 illustratively includes a transmitter, such as a RF transmitter, and a receiver, such an antenna. Illustratively, the satellite receiver 20 and the wireless network clients 80 and 90 communicate through a wireless network 25, and the satellite receiver 20 converts the tuned video signals into packets having destination addresses as network addresses of wireless network clients 80 and 90, so that the packets can be transmitted to the two televisions 60 and 70. The televisions 60 and 70 can be, but not limited to, SDTVs, HDTVs, or computer monitors, and the wireless network clients are devices that can receive packets from the wireless network 25, such as a PC equipped with a wireless network interface card.

Although illustrated as using a wireless network, if a dwelling already has a wired network, such as an Ethernet, the wired network can be used in place of the wireless network.

Although the displays 30, 50, 51, 60, and 70 are illustrated as televisions, other display devices, such as computer monitors, can be used as well. If computer monitors are used for the displays 50 and 51, the video signals transmitted by the in-house coaxial cable system 40 should be converted to a format suitable for the computer monitors. If computer monitors are used for displays 60 and 70, the wireless network clients 80 and 90 may be personal computers having wireless interface modules connected to the wireless network 25.

For billing and other purposes, the satellite receiver 20 should also include a call back link (not shown), such as a telephone link, to the broadcast source, so that a user can, for example, purchase a television program. This call back link should be shared by all televisions 30, 50, 51, 60, and 70, and controlled by their associated remote controls. Advantageously, all call back data streams from all the televisions are transmitted using the same call back link.

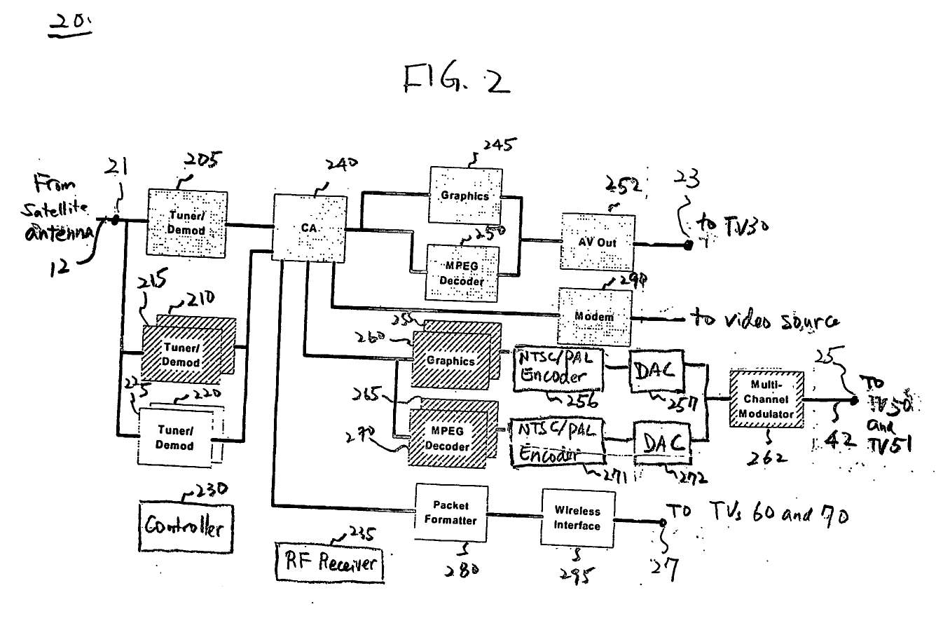

FIG. 2 is an embodiment of the satellite receiver 20 shown in FIG. 1. The satellite includes a controller 230 for controlling other modules, such as tuners (shown as Tuner/Demod in FIG. 2) 205, 210, 215, 220, and 225, in the satellite receiver 20. The controller 230 communicates with other modules using a bus (not shown), such as an IIC bus. As used herein, the term “controller” represents various devices including, but not limited to, microprocessors, microcomputers, microcontrollers and controllers.

For clarity of description, certain conventional elements associated with the satellite receiver 20, such as certain control signals, power signals, and/or other elements may not be shown in FIG. 2.

Each tuner is associated with a television. Illustratively, the tuners 205, 210, 215, 220, and 225, are respectively associated with the televisions 30, 50, 51, 60, and 70. Each tuner tunes to a channel as instructed by the controller 230, and demodulates video signals from that channel into a demodulated video stream. All the demodulated video streams are fed to a conventional conditional access module 240 (shown as “CA” in FIG. 2) for decryption purposes before they are distributed to respective down stream modules. The conditional access module 240 is not required to practice the principles of this invention. Advantageously, only one conditional access module and/or card are needed for supporting multiple televisions in a dwelling, reducing the cost and confusion to a user and simplifying the billing function for both a user and a service provider.

In this illustration, a broadcast video signal is formatted as a MPEG, such as MPEG-2, stream. The demodulated video stream (a MPEG stream in this illustration) from the tuner 205 is fed to a MPEG decoder 250, which decodes the demodulated video stream into a decoded video stream. The decoded video stream is then directly fed to the television 30 through a video driver (shown as “AV Out” in FIG. 2) 252, which is operative to perform various audio/video processing functions, which enable video and/or aural outputs via the television 30. Optionally, graphics, text, and video generated by a graphics module 245 can be conventionally combined with or replaced by the decoded video stream before transmitted to the television 30.

Illustratively, the television 30 is a digital device. If the television 30 is an analog device, the decoded video stream should be encoded as NTSC signals or other types of signals, such as PAL and SECOM, and converted to analog signals. As used herein, the decoded and the encoded video signals are called baseband video signals because the decoded and the encoded video signals do not include a carrier.

Similarly, demodulated video streams from the tuners 210 and 215 are respectively fed to MPEG decoders 255 and 270, which decode the demodulated video streams into respective decoded video streams. Each decoded video stream is encoded by an encoder (element 56 or 71 in FIG. 2) into an encoded video stream in accordance with a standard television format, such as NTSC or PAL, and the encoded video stream is converted to an analog video signal by a digital-to-analog converter (DAC) (element 57 or 72 in FIG. 2). Each analog video signal is modulated by a multi-channel modulator 262 with a different carrier frequency in a frequency band suitable for the in-house coaxial cable system 42. The multi-channel modulator 262 may include a different input port in a module for each analog video signal, or may include a different module for each analog video signal. All modulated signals are coupled to the in-house coaxial cable system 42. The decoded video streams from the MPEG decoders 255 and 270 can be combined with or replaced by graphics, video, and/or text generated by respective graphics modules 260 and 265.

Although the two analog video signals illustratively have the same standard television format, each can have a different standard television format. For example, one analog video signal can have a NTSC format, while the other has a PAL format. Furthermore, although illustrated as two sets of tuner, MPEG decoder, and graphics module, more or fewer sets can be provided dependent upon how many televisions are to be supported and how many channels that the multi-channel modulator 262 can support.

The demodulated video streams, which include MPEG (e.g. MPEG-2) packets, from the tuners 220 and 225 are fed to a packet formatter 280, which formats the MPEG packets into IP packets using conventional methods. The IP packets are then transmitted by a wireless interface module 295 using conventional methods through the network 25 to the wireless network clients 80 and 90 coupled respectively to the televisions 60 and 70. For each IP packet from a tuner, the packet formatter 280 attaches an IP address of one of the two televisions 60 and 70, which is associated with the tuner.

In this embodiment, the network 25 is a TCP/UDP/IP network using, for example, IEEE 802.11 standards, or HiperLAN2. HiperLAN2 is preferred because HiperLAN2 provides parameterized QOS (Quality of Service) and appears to perform better in video networking applications. For example, the throughput of 802.11a/e depends on the bit error rate (BER). By contrast, the throughput of HiperLAN2 does not depend on the BER in the FEC (Forward Error Correction) mode. For a second example, in broadcast mode, with HiperLAN2, several receivers can get the same stream without data duplication; 802.11a/e may have to duplicate the data stream for each receiver.

Although illustrated as using a TCP/UDP/IP protocol suite, other protocol suites, such as an OSI (Open System Interconnect) seven-layer protocol suite, can be used as well.

In this illustration, the wireless interface module 295 is assigned a predetermined IP address, so that wireless network clients 80 and 90 can communicate with the wireless interface module 295. The wireless interface module 295 also acts as a DHCP (dynamic host control protocol) server, which dynamically assigns a different IP address to each of the wireless network clients 80 and 90. In an alternative embodiment, the IP address of each of the wireless network clients is pre-assigned, for example, in the factory or by a user, and the wireless interface module 295 discovers the IP addresses using a conventional discovery protocol.

In either case, each wireless network client should request the device identification code from the associated display, and transmits this information to the wireless interface module 295, which provides the IP address and the corresponding identification code to the controller 230. The controller 230 maps the identification code to a tuner, and provides the IP address/tuner information to the packet formatter 280, so that the packet formatter 280 can attached the correct IP address to IP packets derived from video signals coming from a particular tuner.

When the wireless interface module 295 receives the IP packets, the wireless interface module 295 can send the IP packets using either TCP or UDP protocol. The scheme described so far is the unicast scheme, i.e., each MPEG (such as MPEG-2) stream is transmitted to a specific IP address associated with a television, although a multicast scheme is applicable as well.

If the televisions 60 and 70 share the same tuner and receive the same video signals from that tuner, the controller 235 should inform the packet formatter 280 that that tuner is associated with the IP addresses of the wireless network clients 80 and 90 respectively coupled to the televisions 60 and 70, so that the packet formatter 280 can broadcast the video signals to both televisions. The packet formatter 280 may insert a multicast IP address in each packet coming from that tuner, or it can duplicate the packet for each IP address, although the multicast scheme is preferred.

Although illustrated as supporting two wireless network clients, more or fewer wireless network clients can be supported. However, the number of tuners should be adjusted according to the number of wireless network clients supported. Furthermore, although illustrated that the satellite receiver 20 uses either a unicast or multicast scheme, both schemes can be used simultaneously in the receiver. For example, one television may have its own tuner and the unicast scheme should be used for this television, but two other televisions may share just a single tuner and the multicast scheme should be used.

The satellite receiver 20, illustratively, includes a RF receiver 235 for receiving remote control signals from each remote control associated with each of the televisions 30, 50, and 51. Each remote control signal includes a device identification code identifying the originating remote control, which in turn identifies the associated television. When the controller 230 receives a remote control signal, including information such as a satellite position, polarity, transponders, and PID (Packet Identifier in a MPEG-2 transport stream), from the RF receiver 235 for channel select, the controller 230 checks the device identification code in the remote control signal and instructs the associated tuner to tune to the channel specified in the remote control signal.

Although the use of RF remote control signals is illustrated, other control signals can be used as well. For example, for the television 30, an IR remote can be used if the satellite receiver 20 can receive IR remote control signals because the television 30 is collocated with the satellite receiver 30. For the televisions 50 and 51, IR remote controllers can be used as well. However, each of the televisions 50 and 51, or an associated set-top box, should be able to receive an IR remote control signal, format the remote control signal, and transmit the remote control signal through an up channel in the in-house cable system 42 to the satellite receiver 20. A formatted remote control signal should include the device identification code of the originating television.

For televisions 60 and 70, the associated wireless network clients render graphics, such as user interface, themselves. As such, remote control signals are processed by the wireless network clients, not the RF receiver in 235 in the satellite receiver 20. Both IR and RF control signals can be used as long as respective receivers are available in the wireless network clients. Each wireless network client should convert a received remote control signal into IP packets and send the IP packets to the wireless interface module 295 through the wireless network 25. The wireless interface module 295 then informs the controller 230 of the received control information.

Advantageously, the satellite receiver 20 further includes a modem 290 for providing a call back link for data streams coming from all the televisions. When the controller 230 receives a remote control signal for billing purposes, such as buying a pay-per-view program, the controller 230 checks if the call back link has been established. If not, the controller 230 establishes the call back link. After the call back link has been established, the controller 230 should send out each purchase request sequentially if the controller 230 receives several purchase requests. Although a telephone link is illustrated as a call back link, a satellite up link can be used as well.

The foregoing elements of FIG. 2 may be embodied using integrated circuits (ICs) and any given element may, for example, be included on one or more ICs.

While this invention has been described with regard to a few presently preferred embodiments, those skilled in this art will readily appreciate that many alternative modes and embodiments can be carried out Without departing from the spirit and scope of this invention.

1. A receiver comprising:
an input terminal for receiving broadcast signals of a plurality of channels;
a first output terminal for providing first baseband video signals corresponding to first broadcast signals from a first channel;
a second output terminal for providing network packets corresponding to second broadcast signals from a second channel for transmitting to a network coupled to the second output terminal; and
a third output terminal for providing first analog video signals corresponding to third broadcast signals of a third channel, the first analog video signals having a first frequency band transmissible in a transmission medium coupled to the third output terminal, wherein said transmission medium is RG-59 cable.

2. The receiver of claim 1, further comprising:
means for tuning to the first and second channels, and demodulating the respective first and second broadcast signals therefrom;
means for processing the first demodulated signals and generating the first baseband video signals; and
means for processing the second demodulated signals and generating the network packets.

3. The receiver of claim 2, wherein a first network client is connected to the network for receiving the network packets.

4. The receiver of claim 3, wherein the means for generating the network packets serves as a dynamic host configuration protocol server for automatically assigning the first network client a network address.

5. The receiver of claim 3, wherein the first network client is pre-assigned a network address and the means for generating the network packets discovers the network address of the network client using a device discovery protocol.

6. The receiver of claim 3, wherein a second network client is connected to the network and has a different network address.

7. The receiver of claim 6, wherein the network packets are multicast packets, so that both the first and second network clients receive the network packets.

8. The receiver of claim 6, wherein the network packets are unicast packets.

9. The receiver of claim 8, wherein the unicast packets have destination addresses as a network address associated with the first network client.

10. The receiver of claim 6, wherein the first and second network clients are computers having a network interface module connected to the network.

11. The receiver of claim 1, wherein the network uses TCP/UDP/IP protocols.

12. The receiver of claim 11, wherein the network is a wireless network

13. (canceled)

14. The receiver of claim 1, wherein the tuning means also tunes to the third channel, receives the third broadcast signals from the third channel, and generates third demodulated video signals from the third broadcast signals.

15. The receiver of claim 14, further comprising means for processing the third demodulated video signals and generating the first analog video signal.

16. The receiver of claim 15, wherein the tuning means also tunes to a fourth channel, receives fourth broadcast signals from the fourth channel, and generates fourth demodulated video signals from the fourth broadcast signals.

17. The receiver of claim 16, further comprising means for processing the fourth demodulated video signals and generating a second analog video signal having a second frequency band different from the first frequency band for transmission using the transmission medium.

18. The receiver of claim 17, wherein the first and second frequency bands are below 1 GHz.

19. The receiver of claim 18, wherein the transmission medium includes a RG-59 cable.

20. The receiver of claim 17, wherein the tuning means tune to the four channels in response to remote signals from respective remote controls.

21. The receiver of claim 2, further comprising a conditional access module for decrypting the demodulated signals.

22. The receiver of claim 1, further comprising a modem providing a callback link.
